(19) United States
(12) Patent Application Publication
(10) Pub. No.: US 2017/0236207 A1
(43) Pub. Date: Aug. 17, 2017

(54) SYSTEMS AND METHODS FOR OPERATING A PHYSICAL MODEL SIMULATING A COMPARATIVE ASSESSMENT OF RESOURCES

(71) Applicant: WGC USA ASSET MANAGEMENT COMPANY, LLC, New York, NY (US)

(72) Inventors: Benoit Autier, New York, NY (US); Brian Bellardo, New York, NY (US); Gregory Collett, New York, NY (US); William Rhind, New York, NY (US)

(21) Appl. No.: 15/431,518

(22) Filed: Feb. 13, 2017

Related U.S. Application Data
(60) Provisional application No. 62/294,172, filed on Feb. 11, 2016.

(51) Int. Cl. G06Q 40/06

(52) U.S. Cl. CPC G06Q 40/06

(57) ABSTRACT

Systems and methods for implementing a physical model simulating a comparative assessment of resources, the system provides a flexible mechanism to physically model in real or near-real time a comparative analysis of a valuation of a number of resources, simulating a comparison between a resource comprising the model with one or more other resources. A test suite running on a network mimics hypothetical evaluations in an interactive environment and determines how particular proportions of assets affect the allocation of resources in the environment. The disclosed systems and methods comprise a physical model and network which is enabled to be self-supporting.

### TECHNICAL FIELD

The present disclosure generally relates to the field of comparative analysis and operations of systems used in that field. More particularly, this disclosure relates to methods and systems for creating and operating a physical model of a comparative assessment of resources system.

### BACKGROUND

There are many asset classes in which investors would like to invest that are difficult to access. Although investment vehicles exist that allow investors to invest in some of the hard-to-access asset classes, these investment vehicles have at least the following drawbacks—they (1) are not available to retail investors, (2) are not exchange-traded, (3) subject investors to the full credit risk of the investment vehicle issuer, (4) subject investors to taxation at the entity level of the investment vehicle, and/or (5) present investors with all or some combination of the foregoing drawbacks. As a skilled artisan understands, these problems can be compounded if an investment can only be transacted in a single currency.

The United States Dollar (“USD”) is the most widely traded currency in the world and the USD is used as the standard unit of currency in international markets for certain commodities, such as gold bullion and petroleum. In order to invest in such commodities, investors are limited to trading for the commodities using the USD. There are, however, many advantages to trading commodities in foreign currencies and many reasons why an investor would seek to trade in commodities in currencies other than the USD. Indeed, the importance and advantages of diversification is widely known, further, having certain asset classes, specifically commodity assets, acquirable in only one currency makes that asset class inaccessible to many investors. And even if not technically inaccessible, an investor seeking to trade a commodity (e.g. gold) using a foreign currency, is typically required to pay a number of fees and make multiple transactions to do so, resulting in a highly inefficient investment structure.

An exemplary embodiment of this disclosure thus relates to systems and methods for implementing an exchange-traded investment vehicle tracking the value of an asset or combination of assets, by holding a different asset in the accounts. Through this system, the shortcomings of the current commodity trading systems are addressed and mostly eliminated. While some of the embodiments outlined below are described in relation to the use of gold as a collateralizing asset, and a combination of foreign currencies as a tracked asset, it will be understood that the systems and methods described herein can apply equally to other types of commodities and non-commodity assets. Thus, the following descriptions should not be seen to limit the system and methods described herein to any particular type of non-commodity asset or commodity.

### BRIEF DESCRIPTION OF THE DRAWINGS

For a more complete understanding of the present disclosure and its advantages, reference is now made to the following description taken in conjunction with the accompanying drawing, in which like reference numerals represent like parts:

FIG. 1A is a block diagram illustrating an exemplary embodiment of a model in accordance with certain embodiments of the disclosure;

FIG. 1B is a block diagram illustrating an exemplary embodiment of a model in the form of a fund in accordance with one embodiment of the disclosure;

FIG. 1C is a block diagram illustrating an exemplary embodiment of a system performing the method in accordance with one embodiment of the disclosure;

FIG. 2 is an illustration of a block diagram according to an embodiment of the present disclosure;

FIG. 3A is an illustration of a table in accordance with an embodiment of the present disclosure;

FIG. 3B is an illustration of a table in accordance with an embodiment of the present disclosure;

FIG. 3C is an illustration of a data packet in accordance with an embodiment of the present disclosure;

FIG. 4A is a flowchart illustrating a method in accordance with an embodiment of the present disclosure;

FIG. 4B is a flowchart illustrating a method in accordance with an embodiment of the present disclosure;

FIG. 4C is a flowchart illustrating a method in accordance with an embodiment of the present disclosure;

FIG. 4D is a flowchart illustrating a method in accordance with an embodiment of the present disclosure;

FIG. 5A is an illustration of a table in accordance with an embodiment of the present disclosure; and

FIG. 5B is an illustration of a graph in accordance with an embodiment of the present disclosure.

It is to be appreciated that the drawings described herein are presented for illustrative purposes only. Moreover, common but well-understood elements and/or features that may be useful or necessary in a commercially feasible embodiment may not be shown in order to facilitate a less hindered view of the illustrated embodiments.

### DETAILED DESCRIPTION

In certain embodiments, the present disclosure relates to methods and systems of creating and managing a fund tracking the performance of an index designed to measure daily returns of an investment in an asset as though an investor had invested in the asset in terms of one or more other assets. Because shares in the fund may be listed and publicly traded on a stock exchange, the shares may provide institutional and retail investors with indirect access to a commodity or other asset, which is typically traded only in USD, or another currency, as though the investors had invested one or more assets in the commodity, rather than through a USD purchase of the commodity.

In certain embodiments, an investment vehicle may comprise a fund physically holding a collateralizing asset. These funds seek to track the daily change in value of a tracked asset or combination of assets. Some embodiments relate to the use of gold as a collateralizing asset and the use of a basket of reference currencies as a tracked combination of assets. Such an embodiment may comprise a fund physically holding gold bullion in an amount adjusted to track the performance of a hypothetical investment of the basket of reference currencies. Some embodiments relate to the transfer of shares of an investment in a fund traded on a securities exchange, with the embodiment relating to the management of a commodity pool and a collateralizing asset delivery system. Some further embodiments relate to the coordination of a commodity pool operator and collateralizing asset delivery providers through a collateralizing asset delivery agreement.

By way of example, known amounts of a held asset may be physically deposited into a fund by a held asset delivery provider and according to a held asset delivery agreement. The amount of held asset stored in the fund may be associated with a level of an index. The amount of held asset stored in the fund may, from time to time, be adjusted to reflect the performance an investor would see if the investor were able to invest one or more other assets in the held asset. Specifically, the held asset may be a commodity (e.g. gold bullion), which is traded only in one currency (e.g. USD) around the world, and the one or more other assets may be a basket of foreign currencies (e.g. Euro, Swiss Franc, Canadian Dollar, etc.) of various proportions (e.g. 30% Euro, 30% Swiss Franc, and 40% Canadian Dollar).

The fund may also comprise a commodity pool, which may be used to physically store the asset held within the fund. A private investment structure that combines investor contributions to be used in the futures and commodities trading markets, the commodity pool, or fund, may be used as a single asset entity to gain leverage in trading, in the hopes of maximizing profit potential. As skilled artisans would understand, the title commodity pool is a legal term as set forth by the National Futures Association (NFA), regulated by the Commodity Futures Trading Commission (CFTC) and the National Futures Association in the U.S., rather than by the Securities and Exchange Commission, which regulates other market activity.

Within the exemplary fund, one or more accounts holding the held asset may be created. For example, an allocated held asset account and an unallocated held asset account may be created. An unallocated held asset account may be established with a custodian on behalf of the fund and facilitated by executions of an unallocated held asset account agreement. The unallocated held asset account may be used to facilitate the transfer of held asset (e.g. gold bullion) in and out of the fund. It may also be used to transfer held asset deposits and held asset redemption distributions between authorized participants and the fund in connection with the creation and redemption of creation units. They may also be used in connections with the transfers of the held asset to or from the held asset delivery provider.

An allocated held asset account may be established with a custodian on behalf of the fund by an allocated held asset account agreement. The allocated held asset account may be used to hold the asset that is transferred from the unallocated held asset account to be held by the fund in allocated form (e.g. individually identified bars of gold bullion). In certain embodiments, the held asset may be silver, in other circumstances, the held asset must meet certain standards and requirements, for example gold bullion may be required to meet the requirements of London Gold Delivery Standards. Other commodities and types of held assets obviously may be required to meet other standards. In certain embodiments, the value of the held asset may be transparent and verifiable, such as the value according to the London Bullion Market Association Gold Price. A held asset delivery provider may be, in certain situations, an entity capable of physically delivering to or from the fund amounts of the held asset equal to the change in the index value. The delivery may be in accordance with a held asset delivery agreement, placing certain requirements on the physical attributes of the held asset to be stored in the fund.

For example, in certain embodiments a particular index may represent the daily performance of a long position in physical gold and a short position in a basket of foreign currencies. Such an index may reflect the price of gold in USD, adjusted by the price of each reference currency comprising the basket, as measured against the USD. Such an index may be designed to measure daily gold bullion returns as though an investor had invested in gold bullion in terms of the basket comprised of the reference currencies. In general, such an index may be intended to increase in value when the price of gold increases and/or when the value of the USD increases against the value of the reference currencies. The fund may be managed, in one embodiment, to track the performance of such an index.

For a further example, an investment in gold may be secured by physical gold that is stored in secure locations associated with a fund. The amount of gold in the fund may be increased or decreased based on the performance of the tracked index. Such an embodiment may allow for investors to have indirect access to the Gold Bullion market, but with the value of the investment referenced in terms of the basket of reference currencies. In this way, investors may purchase and sell shares of physical gold through traditional brokerage accounts or other investment accounts. Through a single transaction, then, the shares permit investors to achieve exposure to Gold Bullion and the specified reference currencies reflected in the tracked index.

Unlike a USD-denominated direct investment in gold or a USD-denominated investment in a gold exchange-traded fund, which does not provide exposure to a non-U.S. currency, a fund investor need not engage in foreign exchange transactions to obtain exposure to a gold investment. Instead, an investor can gain that exposure through a single transaction, thereby avoiding the difficulty, unpredictability, and expense of engaging in such foreign exchange transactions.

As discussed, an index may be used to track the performance of one or more “tracked assets,” as compared to the held asset. In certain embodiments, the index may be used to reflect the performance an investor would realize, had the investor been able to invest the “tracked assets” in the held asset, all without incurring the many costs and fees associated with making such an investment in the market (e.g. foreign currency exchange fees, etc.). The index may be updated daily, based on opening and closing values of the held asset, etc. An index business day may be any day that is a business day in New York, London and/or any day on which the values of the held asset and/or tracked assets may be published. In the example of a held asset being gold, this may include any day on which the LBMA is scheduled to publish the Gold Price, and in the example of a basket of tracked assets being a number of foreign currencies, any day on which the World Markets Company is scheduled to publish prices for each of the Reference Currencies comprising the basket.

The index may be designed to represent the daily performance of a long position in a physical commodity (e.g. gold bullion) or other asset held by the fund and a short position in a basket of assets (e.g. one or more foreign currencies). For example, the index may be designed to represent the daily performance of a long position in physical gold and a short position in a basket of foreign currencies. In such an example, the index may reflect the price of gold in USD, adjusted by the price of each currency comprising the baskets as measured against the USD.

In general, then, the tracked index is intended to increase in value when the price of the held asset (e.g. gold) increases and/or when the value of the USD increases against the value of the basket of assets. The tracked index is intended to decrease in value when the price of the held asset decreases and/or when the value of the USD declines against the value of the basket of assets. The net impact of these changes may determine the value of the tracked index and owned commodity on a daily basis.

It should also be understood that one or more assets (i.e. assets not held by the fund) may be “tracked” and the value of which may be used to update a tracked index, which may be used to adjust the amount of held assets physically stored in the collateral pool. For example, the tracked assets may be a basket of foreign currencies (e.g. the Euro, the Canadian Dollar, etc.) of various proportions (e.g. 60% Euro and 40% Canadian Dollar). The tracked assets may also be other types of assets, for example stocks, bonds, etc. As with the index, shares of the fund may be intended to increase in value when the price of the asset held by the fund increases and/or when the price of the USD increases against the value of the asset(s) comprising the basket. Fund shares are intended to decrease in value when the value of the asset held by the fund decreases and/or when the price of the USD declines against the value of the asset(s) comprising the basket. The net impact of these changes determines the value of the fund on a daily basis. Although investors may purchase shares of the fund in USD, the fund is designed to provide investors with the economic effect of holding fund assets in terms of the basket and/or commodity, as opposed to the value of the purchasing USD.

In some embodiments, a commodity pool operator (“CPO”) may be used to facilitate investments in the described systems. A CPO may be an individual or organization which operates a commodity pool and solicits funds for that commodity pool. A third party custodian may act as an intermediary between the CPO and any investor or held asset delivery provider. For example, the custodian may handle all client checks, deposits, or withdrawals directly.

It should also be appreciated that control and/or management of the funds described may be performed via the use of one or more computers or servers in communication with one or more markets or other data sources via a network. Control and/or management of the fund may comprise accessing physical amounts of a commodity and may comprise storing such physical amounts of commodity in a secured fund location (e.g. a bank vault).

Computers in communication with all relevant data sources via a network will be required to accurately and efficiently determine current prices and/or values of the held commodity or asset and the tracked assets. Memory of a computer will be used to track the use and history of investments in the fund, updating potentially millions of account values, multiple times daily. The system may track historical values of the held commodity and the tracked assets. The computer system may also determine, based on the values of the commodity and tracked assets, an amount of physical asset which may need to be physically moved into or out of the fund and send alerts to entities required to accomplish the necessary movement of physical asset.

Steps of certain embodiments may be performed only through the use of a physical fund holding physical amounts of the held commodity. Holding a physical commodity provides many benefits. For example, at all times the actual value of the fund may model the calculated value of the simulated trade of the basket of assets for the commodity. Holding physical amounts of the commodity may also provide the benefit of having a self-supported fund, as costs associated with controlling and/or managing the fund may be paid by simply selling portions of the held commodity. Holding physical amounts of the commodity may also provide security for investors, creating a tangible demonstration or model of the actual value of the hypothetical investment of the basket of assets for the held commodity. Such security is not possible using a pen and paper based system or a system performed within a human mind or any system lacking such physical amounts of held commodity.

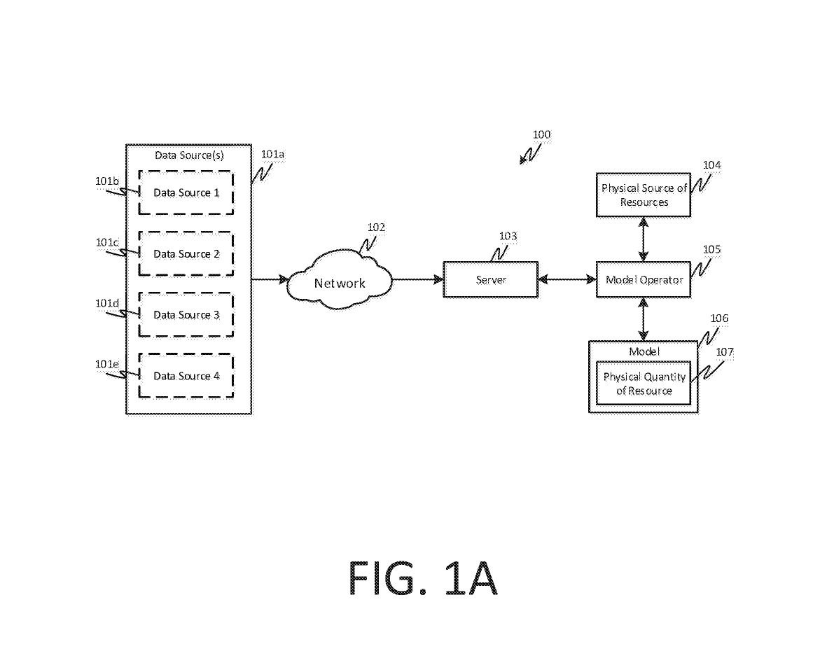

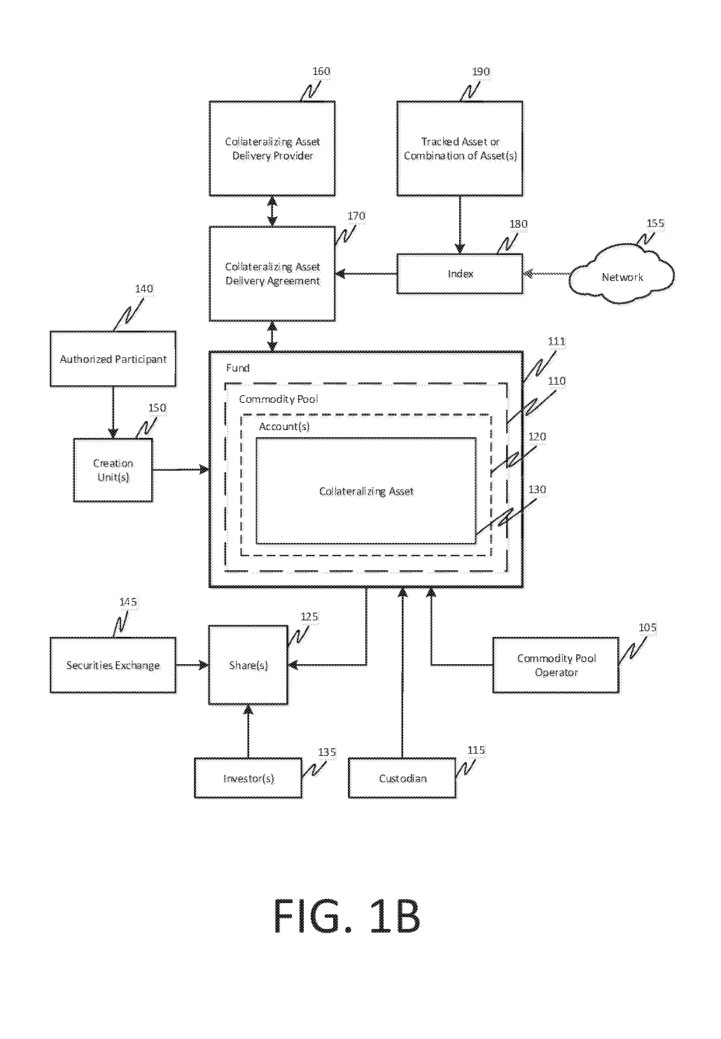

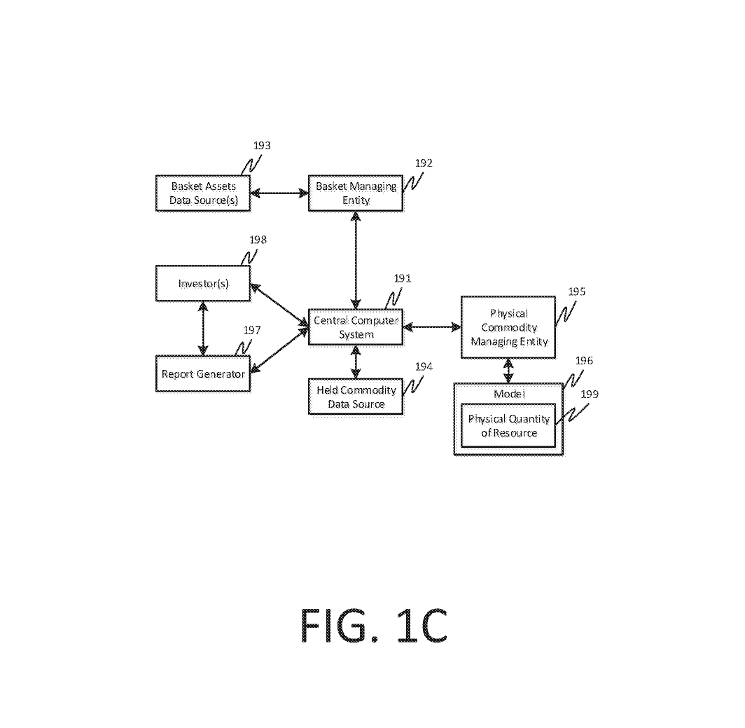

An exemplary embodiment of a system 100 in accordance with the disclosure is illustrated in FIG. 1A. As illustrated, a model operator 105 may be in communication with a source 104 of the physical resource held by the model, a network connected server 103, and a model 106 holding a physical quantity of a resource 107.

The model operator 105 may be a computerized system capable of physically moving resources between the model and the physical source of resources. Alternatively, the model operator may be any entity capable of instructing a physical source of resources to deposit or withdraw resources to or from the model. The model 106 may be a physical location such as a vault in a bank capable of storing a quantity of a physical resource.

The physical quantity of resource 107 held by the model 106 may be a physical commodity such as gold, petroleum, rubber, copper, lead, zinc, tin, aluminum, aluminum alloy, nickel, cobalt, molybdenum, recycled steel, platinum, palladium silver, etc. In some embodiments, the resource held in the model may be publicly traded on a particular market exchange, such as the London Metal Exchange, COMEX, NYMEX, etc. The value of the resource held in the model may be set by a particular market exchange.

The physical source 104 of the resource held by the model 106 may be any entity capable of delivering physical quantities of the resource to and from the model. For example, in the case of gold, the resource (i.e. gold bullion) may be delivered by any gold delivery agent capable of delivering gold matching a standard set by the London Bullion Market Association (“LBMA”). The model operator may set particular standards and rules regarding the delivery of the resource.

The model operator 105 may be in contact with a server 103. The server 103 may be used by the model operator 105 to determine current and historical values and exchange rates and other factors required to determine a quantity of the held resource to adjust in the model. The server 103 may lookup data related to the held resource 107, as well as a number of other assets from data source(s) 101a-e via a network 102. Data sources 101a-e may optionally be present in the system and may be one or more market listings of prices of the asset(s) and model resource as traded on particular markets. The looked-up data may be stored in one or more tables on the server to be accessed by the model operator.

FIG. 1B illustrates a fund 111 according to an embodiment. Particularly, a commodity pool 110 may be established within the fund 111 to physically hold a collateralizing asset 130 (e.g. gold bullion). The collateralizing asset 130 may in some embodiments be any type of asset which may be physically stored. The collateralizing asset 130 may be stored in one or more accounts 120 included in the fund 111. The account(s) may be used to physically receive and store the collateralizing asset 130 deposited by authorized participants 140 with the commodity pool 130. Collateralizing assets 130 may be deposited into or withdrawn from the fund 111 by authorized participants, through creation units 150, or by a collateralizing asset delivery provider 160. Creation units 150 may in certain embodiments be issued to an initial purchaser for the deposit into the fund 111 of collateralizing asset 130 in connection with the formation of the fund 111. A participant agreement may be entered into by each authorized participant 140 with respect to the fund 111 which provides the procedures for the creation and redemption of creation units and for the delivery of collateralizing assets 130 required for such creations and redemptions.

In one embodiment, the CPO may appoint one or more custodians 115 to maintain and administer the commodity pool's collateralizing asset accounts and safeguard the commodity pool's collateralizing asset. Responsibilities of the custodian can include (1) transferring the collateralizing asset into the fund in connection with the development of creation units 150 by authorized participants, and (2) delivering the collateralizing asset into or out of the fund pursuant to the collateralizing asset delivery agreement.

The fund 111 may also be set up to track the performance of an index 180, which may be designed to represent the daily performance of a long position in the collateralizing asset 130 and a short position in one or a combination of tracked assets 190. The tracked index may be determined based on prices of the collateralizing asset and the tracked asset(s) as publicly listed. For example, the LBMA Gold Price AM for gold and the WMR Fix for currencies.

In some embodiments, the value of the tracked asset or combination of assets 190 may be measured by an index 180. For example, in tracking the price of gold in terms of a group of foreign currencies using gold as a collateralizing asset, the Solactive GLD® Long USD Gold Index may be used. In other embodiments, other indexes may be used.

The economic impact of changes in the value of the tracked asset or combination of assets may be reflected on a minute-by-minute, hourly, or daily basis in the fund by moving an equivalent amount of the collateralizing asset into or out of the fund. In this way, the fund tracks the performance of the tracked asset or combination of assets by entering into a transaction each business day with a collateralizing asset delivery provider 160. Shares 125 or interests corresponding to the actual, physical value of the collateralizing asset 130 held in one or more accounts 120 of the fund 111 may be created and sold via a securities exchange 145 or other market. In this way, investors 135 may invest in the fund 111 by buying shares 125 associated with the value of the collateralizing asset 130 physically stored in the fund 111.

In general, if there is a loss in value of the tracked asset or combination of assets, the fund physically delivers an equivalent amount of the collateralizing asset to the collateralizing asset delivery provider 170. If there is a gain in value of the tracked asset or combination of assets, the collateralizing asset delivery provider 170 physically delivers an equivalent amount of the collateralizing asset to the fund 111. A collateralizing asset delivery agreement 170 may be entered into with a collateralizing asset delivery provider 160, which in some embodiments may be a bank, to standardize these transactions. Obviously, to accomplish these transactions, a number of communications will flow from the system to the collateralizing asset delivery provider and the entity holding the physical collateralizing asset.

In some embodiments, the net asset value of the fund will increase or decrease each business day, or more frequently, based primarily on two factors. The first is the change in value of the collateralizing asset measured in USD from the prior value point. The second is the change in the value of the tracked asset or combination of assets from the prior value point.

The fund may be managed by a CPO 105, a trustee, and/or an administrator. On a daily basis, the collateralizing asset is either deposited into the fund or withdrawn from the fund 111 corresponding to a collateralizing asset delivery agreement 170 between the CPO 105 and a collateralizing asset delivery provider 160. The amount transferred is the collateralizing asset delivery amount.

The role of CPO may include the responsibilities of managing the collateralizing asset delivery mechanism, receiving and storing the collateralizing asset in the commodity pool account, issuing shares 125 or interests in the commodity pool to investors 135, and generally keeping the books and records of the commodity pool. Responsibilities of the CPO may also include, among other things, calculating the amount of collateralizing asset due to, or from, the collateralizing asset delivery provider.

In one embodiment, the fund is established when authorized participants 140 develop creation units 150 in the fund, typically by depositing a collateralizing asset into the fund. Creation units are blocks of shares which may be transferred or traded on a security exchange 145. Shares or interests in the fund may also be traded on a securities exchange, thereby creating a robust secondary market for the commodity pool's shares. The commodity pool's shareholders or interest holders, when creating or redeeming shares or interests, are obligated to provide to the commodity pool or receive from the commodity pool, as the case may be, an amount of the collateralizing asset equal to their pro rata share of the net asset value of the commodity pool.

One exemplary aspect of this system is the collateralizing asset delivery mechanism managed by the collateralizing asset delivery provider and the commodity pool operator and/or trustee/administrator. Under the collateralizing asset delivery mechanism, the collateralizing asset delivery provider and commodity pool operator and/or trustee/administrator, respectively, are obligated to make and take delivery of the collateralizing asset in an amount designed to allow the commodity pool to reflect how the commodity pool would have performed if the commodity pool had held the tracked asset(s).

In certain embodiments, the method and system as described may be performed via a system of a number of entities communicating via a network as illustrated in FIG. 1C. As can be appreciated, the system may be comprised of a number of entities. The blocks shown in FIG. 1C may be units of a single computer system or some or all blocks may be separate units communicating via a network. The network may be the internet or a closed system. The connections between entities may be any network connection known in the art, including but not limited to, hard connections, WIFI, cellular, etc.

As illustrated in FIG. 1C, a central computer system 191 (e.g. a server or computer on a network) may be in communication with a number of entities. For example, the central computer system 191 may be in communication with a physical commodity managing entity 195 (e.g. a computer accessible by an entity capable of delivering and withdrawing physical commodity 199 to and from the fund and/or model 196). The central computer system 191 may also be in communication with a held commodity data source 194 (e.g. a market on which values or prices of the commodity 199 held in the fund and/or model 196 is listed). Such a communication may be via a website or other network source. The central computer system 191 may also be in communication with a basket managing entity 192. For example, a computer system may be used to store data indicative of the assets comprising the basket and the percentage of the basket which each tracked asset makes up. Such a computer system may be operable by a basket managing entity 192. The basket managing entity 192 may communicate via a network with a basket assets data source 193 (e.g. one or more markets on which values or prices of the assets held in the basket are listed). Such a data source 193 may comprise a website or other information source accessible via a computer. The central computer system 191 may also be in communication with a report generator 197 operable to store data relating to the fund and/or model 196 and the tracked assets comprising the basket. The report generator 197 may receive such data from the central computer system 191 or other entities via a network connection.

The system illustrated in FIG. 1C may operate through a series of electronic instructions sent between the entities 191-199 via the network. For example, at a start of a business day, the central computer system 191 may send an electronic instruction communication to the basket managing entity 192. The basket managing entity 192 may then request a current value of each of the assets held in the basket from the data source 193. The basket managing entity 192 may then receive the current value of each of the assets in the basket from the data source 193 via the network. The basket managing entity 192 may then send the values of the assets in the basket to the central computer system 191.

The central computer system 191 may request data from the data source 194 regarding a value of the held commodity. The central computer system 191 may also request data from the physical commodity managing entity 195 regarding information indicative of the commodity held in the fund and/or model 196. The central computer system 191 may automatically perform calculations as discussed herein to calculate an amount of commodity to one of move into or out of the fund and/or model 196. Such calculation may then be used by the central computer system 191 to generate an instruction communication to be sent to the physical commodity managing entity 195, instructing the physical commodity managing entity 195 to perform the requisite task.

All data received and transmitted throughout the system, including, but not limited to, information regarding values of tracked assets and the held commodity and the physical amount of commodity held by the fund and/or model 196 may be stored in memory in the central computer system 191. Such data may be catalogued in storage and used by the report generator 197 to generate reports. The reports may be accessed by investors 198 via the network or via the central computer system 191. The central computer system 191 may also comprise a monitor with a graphical user interface (“GUI”) operable to allow users access to control the system and view reports.

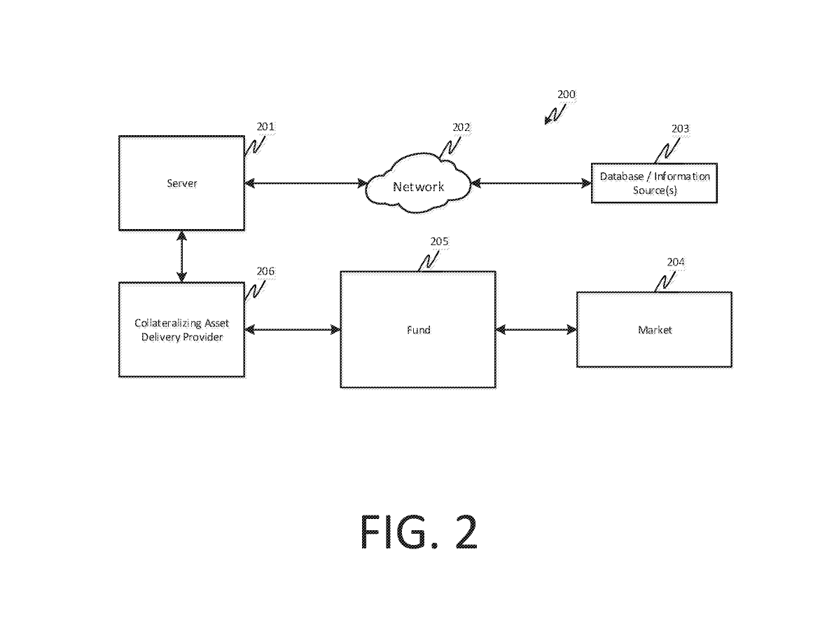

A more general overview of an embodiment 200 of a passive exchange traded investment vehicle is illustrated in FIG. 2. As illustrated, the system may comprise a fund 205. Shares tracking the value of the fund 205 may be traded on a public or private market 204. The contents of the fund 205 may be managed by a collateralizing asset delivery provider 206. The collateralizing asset delivery provider 206 may determine an amount of collateralizing asset to deliver to or withdraw from the fund 205 based on an index. The collateralizing asset delivery provider 206 may determine the level of the index based on information accessed from a database or information source 203 via a server 201 connected to a network 202. For example, the collateralizing asset delivery provider 206 may determine a current or previous value of the collateralizing asset in the fund 205 based on a market trading price accessed via the server 201. The collateralizing asset delivery provider 206 may also determine a number of exchange rates of tracked assets via the network 202 and store them on the server 201 in order to calculate the index level and to determine the amount of collateralizing asset to direct be delivered to or withdrawn from the fund 205.

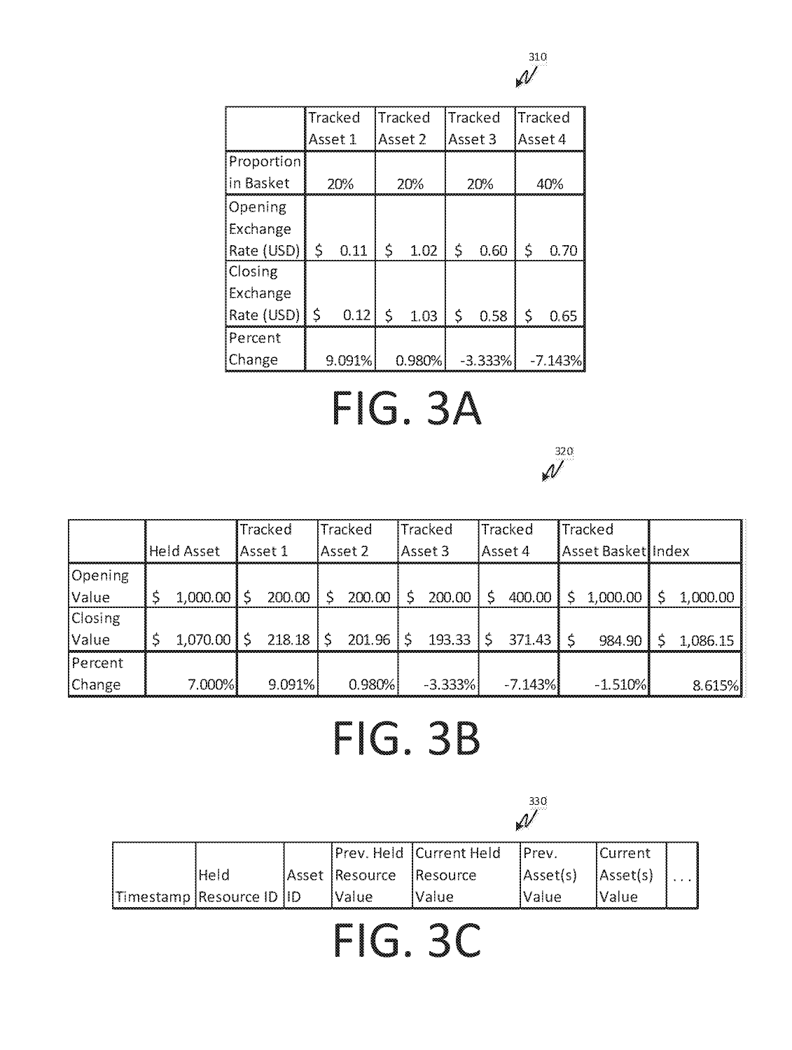

In certain embodiments, a number of tracked assets may be used to determine the index level. As illustrated in the table 310 of FIG. 3A, the tracked assets may make up a different proportion of the basket. For example, in the embodiment illustrated in FIG. 3a, tracked asset 1 makes up 20% of the basket, tracked asset 2 makes up 20% of the basket, tracked asset 3 makes up 20% of the basket, and tracked asset 4 makes up 40% of the basket. The proportion may be a proportion of the overall value of the basket. For example, the tracked asset basket may be valued at $1,000 so that a tracked asset making up 20% of the tracked asset basket may be valued at $200. The tracked assets may be a particular number of shares, some amount of property, or a foreign currency. In certain embodiments, the tracked assets have values which are publicly listed such that the tracked asset basket may be transparent. For example, the tracked assets may be currencies of a number of countries and the value of the tracked assets may be published exchange rates at the opening and closing of a business day. In the example shown in table 310, a first tracked asset (“Tracked Asset 1”) may open at an exchange rate of $0.11 and close at an exchange rate of $0.12 for an overall daily percent change of 9.091%.

The value of the asset physically held by the fund, i.e. the collateralized asset, in certain embodiments may also be used to determine the index level. The values used to determine the index level may be measured at the opening and at the closing of the markets tracking the value of the asset. The index level may be determined based on the percent change of the value over the course of that single business day. As illustrated in the table 320 in FIG. 3B, an example Tracked Asset 1 may have an opening value of $200 and a closing value of $218.18 for a total percent change of 9.091% over the business day. In the example of table 320, the total of the tracked asset basket was, at opening, $1,000 and at closing $984.90, for a total daily percent change of −1.510%. In the illustrated example, the value of the tracked asset basket in USD fell by 1.510% illustrating that the USD gained strength compared to the tracked asset basket. In the example, the held asset gained value over the course of the day of 7%.

In certain embodiments, the held asset may be gold bullion and the fund may physically hold that bullion. In certain embodiments, the tracked asset basket may be a basket of a number of currencies, for example the USD, the Euro, Japanese yen, British pound sterling, Canadian dollar, Swedish krona, and Swiss franc, or any combination of these and/or other currencies. The currencies in the basket may be set at a specific proportion of the overall value of the basket, for example 50% euro, 20% Swedish krona, and 30% Swiss franc.

Continuing the example of FIG. 3B, the held asset gained value over the course of the day by 7%, while the tracked asset basket lost value over the course of the day by 1.510%. Because the index seeks to track the performance of an investment of the tracked asset basket in the held asset, the value of the fund is adjusted to reflect such an investment. In this example, the fund would have out-performed the held asset valued in terms of the USD. Accordingly, an amount of the held asset (e.g. gold) must be deposited into the fund to increase the value of the held asset to match the index. To reflect the performance of the held asset in terms of the tracked asset basket, the following formula may be used: (1+R_{GG})=(1+R_{g})×(1+R_{iFX}), wherein R_{GG} is the percentage of the index, R_{g} is the percentage change of the held asset (e.g. in the case of gold, USD per ounce), and R_{iFX} is the approximate tracked asset basket percent change.

As illustrated in FIG. 3C, data used to value the held resource and the tracked assets in the methodology used to calculate, by a computer system or server, the optimum quantity of the resource held in the model may be sent to the computer system or server via a network in the form of a data packet 330. Such a data packet 330 may include information such as a timestamp, an ID associated with the held resource, an ID associated with the tracked asset(s), a previous value of the held resource, a current value of the held resource, a previous value of the tracked asset(s), a current value of the tracked asset(s), and possibly other information.

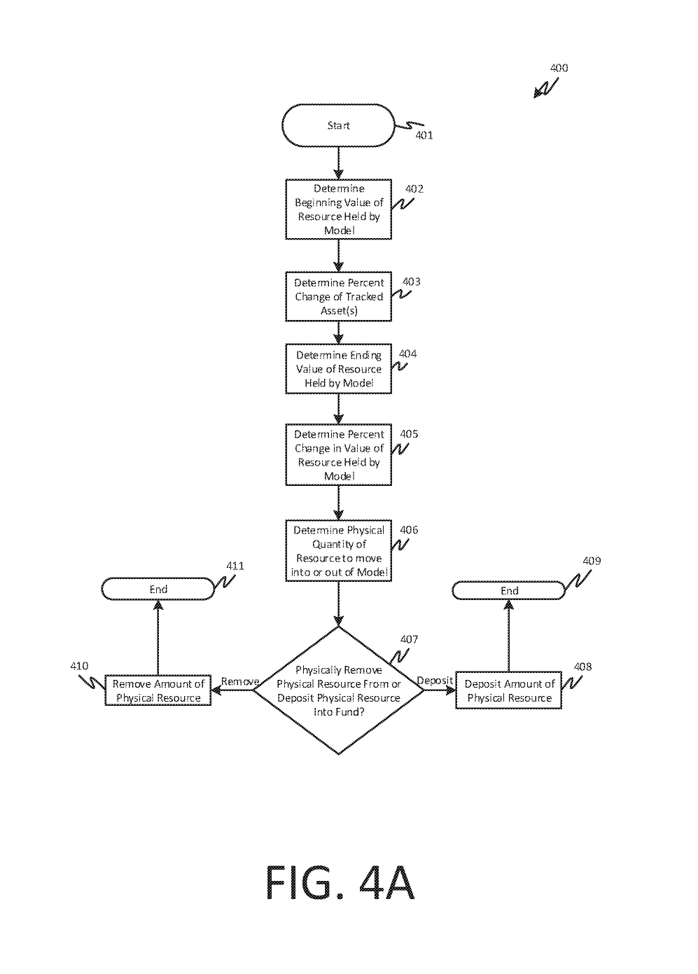

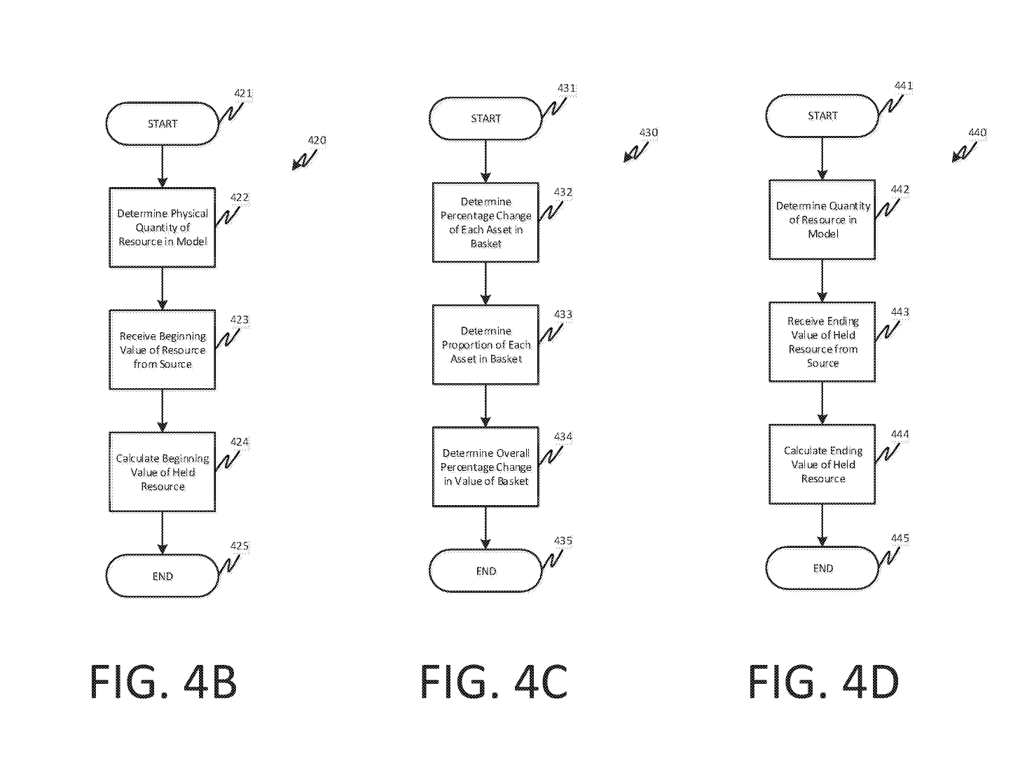

In certain embodiments, a method 400 as illustrated in FIG. 4A may be implemented to adjust the quantity of resources held by the investment model. The method 400 may begin at a start point 401. The method 400 may be performed periodically at any timeframe, for example annually, monthly, weekly, daily, hourly, or in real or near-real time. The method may be performed automatically or upon user command.

At the beginning of the method 400, the beginning value of the resource held by the model may be determined at step 402. This value may be the value of the resource at the time the method begins, or at an earlier point in time. The value may be determined by consulting a published index or other listing of the most recent values of the held resource. For example, in the case of the held resource being gold bullion, the system may determine a price per ounce of gold as published by a market listing. For example, LBMA, CBOT, EURONEXT, Chicago Mercantile Exchange/NYMEX, ICE, etc. The system may then determine the quantity of the resource being held by the model. The beginning value of the resource may be determined by multiplying the value per quantity by the total quantity of the held resource in the model. The quantity may be measured in different units depending on the type of the resource held by the model. For example, the held resource may be measured in terms of bushels, tons, pounds, hundredweight, ounces, gallons, barrels, kilograms, etc. The value may be determined according to the value at opening of a business day.

Next, the method 400 may continue at step 403 in which a percent change in the value of the one or more tracked assets may be determined. The percent change in the value of the one or more tracked assets may be determined according to opening and closing values of the one or more tracked assets as published on a market listing. The basket of assets may comprise a number of assets at different proportions. Each asset may make up a different percentage of the basket. For example, the basket may comprise 20% of a first asset, 30% of a second asset, and 50% of a third asset. The proportion may be based on a total value or a total weight or by some other factor. The proportion of each asset in the basket may be manually set by a model operator.

An example formula which may be used in the case of multiple tracked assets to calculate the overall percentage change of the basket of assets may be as follows: Σᵢ₌₁ⁿA_{Pi}×A_{Ci}, where n is the number of assets in the basket, A_{Pi} is the proportion of the ith asset, and A_{Ci} is the percentage change of the ith asset. The percentage change of the ith asset may be calculated using the following formula:

$$\frac{New Value - Old Value}{Old Value} .$$

The method 400 may continue at step 404 in which an ending value of the resource held by the model may be determined. Similar to step 402, step 404 may comprise determining the quantity of the physical resource held by the model and determining the current or most recent or closing value of the resource as traded on a public market.

At step 405, a percentage change in the value of the resource held by the model may be calculated based on the results of steps 403 and 405. The percentage change may be determined based on the following formula:

$$\frac{New Value - Old Value}{Old Value} .$$

At step 406, a physical quantity of the resource held by the model may be determined to one of move into or move out of the model. The physical quantity of the resource to move into or out of the model may be determined by an equation such as: (1+R_{GG})=(1+R_{g})×(1−R_{iFX}), wherein R_{GG} is the percentage change in the quantity of the held resource, R_{g} is the percentage change in value of the held resource (e.g. in the case of gold, USD per ounce), and R_{iFX} is the approximate tracked asset basket percentage change. As an example, if the percentage change in the value of held resource is 2.7%, the percentage change in the value of the tracked basket of assets is −3.2%, the value of the held resource at the end of the period of time (e.g. one business day) is $1,000 per unit and the quantity of the held resource at the end of the period of time is 100 units, the value of the held resource at the end of the period of time would be $100,000.00, the goal percent change in value of the held resource would be 5.99%, the goal end value of the held resource would be $105,986.40, the goal value of the held resource to move into the model would be $5,986.40 which would be equivalent to 5.9864 ounces.

Other formulas may be used to calculate the amount of resource to move. In certain embodiments, the physical quantity to be moved may be such that the total physical quantity of the resource held by the model after the move reflects a simulation of a trade of the basket of tracked assets at the beginning of the method for the physical resource held by the model. For example, if the value of the basket declines over the period of time used in the method and the value of the resource held by the model rises or stays the same over the same period of time, the theoretical trade would have paid off (i.e. the trade would have benefited the theoretical investor). In such a scenario, the amount of resource held by the model may be increased to simulate the payoff of the trade.

At step 407, the method may comprise determining whether to move the amount of physical quantity of the held resources, determined in step 406, into or out of the model. If the amount of physical quantity held in the model should be reduced, the method may move to step 410 in which an amount of the resource held by the model may be removed. If the amount of physical quantity held by the model should be increased, the quantity of the resource determined in step 406 may be deposited into the model in step 408. Following steps 410 and 408, the method may end at steps 411 and 409 respectively.

FIG. 4B illustrates a method 420 of calculating a beginning value of the resource physically held by the model in accordance with certain embodiments. The method may begin at step 421, in which the system or a custodian of the system begins the process described in FIG. 4A or otherwise desires to calculate a beginning value of the resource held in the model. In step 422, the quantity of the resource held by the model is determined. Such a measurement may be according to historical data stored in a data source on a network, or the amount may be physically measured such as using a scale. For example, a listing of a beginning quantity of the resource and all movements of resources into and out of the model may be stored on a network connected database. In the example of the held resource being gold bullion, the method may comprise determining a number of ounces of gold held in the model.

In step 423, after determining the physical quantity of the resources held in the model, the method may comprise receiving a beginning value of the resource held in the model. This value may be a historical value at a beginning time frame. For example, the value may be from a beginning of a current or previous business day or a value of the resource at some other specific point in time. The value may be determined based on a lookup on a listing of a market accessed via a network.

In step 424, the beginning value of the resource held by the model may be calculated. Such a calculation may comprise multiplying the quantity of the held resource by the value per quantity of the resource. For example a value of gold may be a price in USD per ounce and the quantity measurement of the held resource may be a number of ounces of gold. After determining the beginning value of the held resource in the model, the method may end at step 425.

FIG. 4C illustrates a method 430 of calculating an overall percentage change in value of a basket of assets in accordance with certain embodiments. The method may begin at step 431 and proceed to step 432 in which the method comprises determining a percentage change in the value of each asset in the basket of assets. While in some embodiments the basket may comprise a single asset, in certain embodiments the basket may comprise a number of assets of varying proportion. In step 432, the method may comprise determining a percentage change of each asset individually over a predetermined amount of time (e.g. one business day). For example, this may comprise determining a historical value such as a price per share or an exchange rate at a beginning of a business day, followed by determining a more current value such as the price per share or exchange rate at the end of the business day and calculating the percentage change there between.

At step 433, the method may comprise determining a proportion of each asset in the basket of assets. The proportions may be set by a custodian of the model and stored on a database on a server. For example, the basket of assets may comprise 30% Euro and 70% Canadian Dollar.

At step 434, the method may comprise determining an overall percentage change in the value of the basket. This determination may be calculated by the following formula: Σᵢ₌₁ⁿA_{Pi}×A_{Ci}, where n is the number of assets in the basket, A_{Pi} is the proportion of the ith asset, and A_{Ci} is the percentage change of the ith asset.

FIG. 4D illustrates a method 440 of calculating an ending value of the resource physically held by the model in accordance with certain embodiments. The method may begin at step 441, in which the system or a custodian of the system begins the process described in FIG. 4A or otherwise desires to calculate an ending value of the resource held in the model. In step 442, the quantity of the resource held by the model may be determined. Such a measurement may be according to historical data stored in a data source on a network, or the amount may be physically measured such as using a scale. For example, a listing of a beginning quantity of the resource and all movements of resources into and out of the model may be stored on a network connected database. In the example of the held resource being gold bullion, the method may comprise determining a number of ounces of gold held in the model.

In step 443, after determining the physical quantity of the resources held in the model, the method may comprise receiving an ending value of the resource held in the model. This value may be a historical value at an ending of a time frame. For example, the value may be from an end of a current or previous business day or a value of the resource at some other specific point in time. This value may be determined based on a lookup on a listing of a market accessed via a network.

In step 444, the ending value of the resource held by the model may be calculated. Such a calculation may comprise multiplying the quantity of the held resource by the value per quantity of the resource. For example, a value of gold may be a price in USD per ounce and the quantity measurement of the held resource may be a number of ounces of gold. After determining the ending value of the held resource in the model, the method may end at step 425.

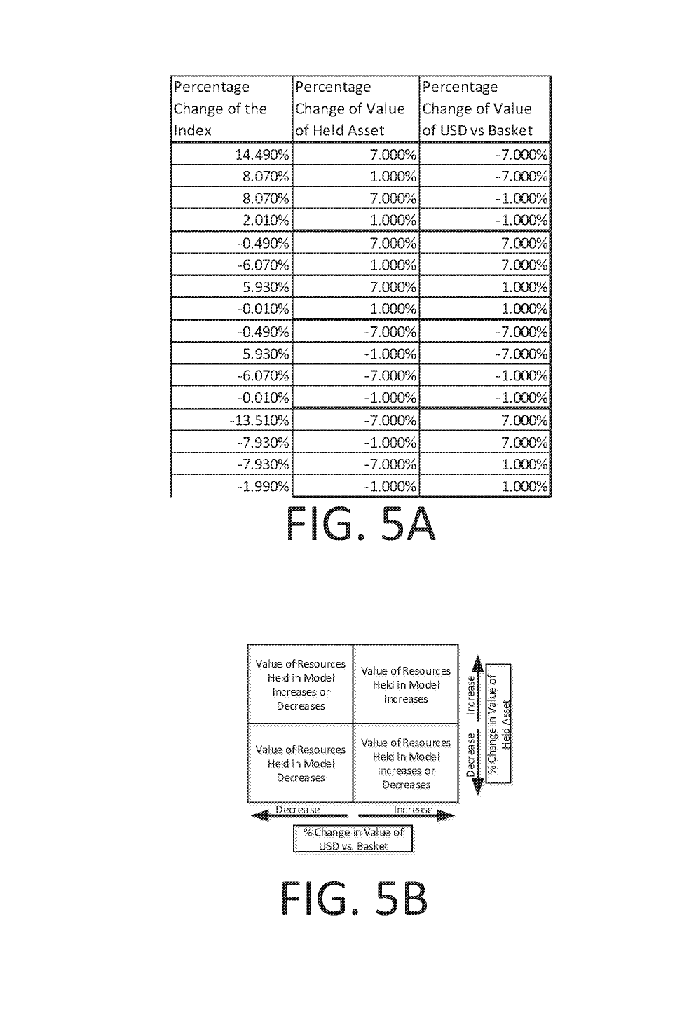

FIG. 5A shows an exemplary table of data in accordance with certain embodiments illustrating an effect on the index given a percentage change in the value of the held resource and a percentage change in value of the basket of tracked assets. As illustrated, an increase in the value of the held resource combined with a drop in the value of the basket of assets (illustrating an increase in the strength of the USD compared to the assets comprising the basket) results in a positive percent change of the index. In contrast, a drop in value of the resource held by the model combined with an increase in the value of the basket of assets should result in a decrease in the index (i.e. a negative percent change of the index). When the index decreases, a delivery provider may withdraw physical resources from the model, while when the index increases, a delivery provider may deposit physical resources into the model. In this way, the quantity of resources held in the model may simulate the performance of an investment of the basket of assets in the resource held by the model.

FIG. 5B further illustrates the relationship between the percent change in the value of the USD versus the basket of assets and the percent change in the value of the held asset. For example, an increase in the value of the held resource combined with an increase in the value of the USD versus the basket of assets may result in an increase in the net value of the resource in the model.

While the above described flowcharts have been discussed in relation to a particular sequence of events, it should be appreciated that changes to this sequence can occur without materially affecting the operation of the embodiment(s). Additionally, the exact sequence of events need not occur as set forth in the exemplary embodiments. Additionally, the exemplary techniques illustrated herein are not limited to the specifically illustrated embodiments, but can also be utilized with the other exemplary embodiments and each described feature is individually and separately claimable.

The above-described systems and methods can be implemented in software using object or object-oriented software development environments that provide portable source code that can be used on a variety of computer or workstation platforms. Moreover, the disclosed systems and methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as a program embedded on one or more personal computers such as an applet, JAVA®, or CGI script, as a resource residing on a server or computer workstation, as a routine embedded in a dedicated communication system or system component or the like. The system can also be implemented by physically incorporating the system and/or method into a software and/or hardware system.

Various embodiments may also or alternatively be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

Provided herein are exemplary systems and methods. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links 5, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeably and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to power control in a wireless transceiver. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:

a method for modeling a financial transaction, the method comprising:
storing information indicative of a reference asset and a basket of assets in a memory;
holding a quantity of resources in a model;
determining, by one or more processors in communication with the memory, a first percent change, the first percent change associated with a first value of a resource held in the model and being compared to the reference asset;
determining, by the one or more processors, a second percent change, the second percent change associated with a value of the basket of assets held in memory and being compared to the reference asset;
determining, by the one or more processors, based on the first percent change and the second percent change, a quantity of a resource to be held in the model thereafter, to one of allocate to the model and remove from the model; and
based on the determination of the quantity of the resource to be held in the model, one of automatically generating and electronically sending an instruction to move the quantity of the resource into or out of the model, wherein the value of the model reflects a direct comparison between the value of the resource and the value of the basket of assets.

Exemplary aspects are directed toward any of the above aspects, further comprising wherein the resource comprises gold bullion.

Exemplary aspects are directed toward any of the above aspects, further comprising wherein the first percent change is determined daily.

Exemplary aspects are directed toward any of the above aspects, further comprising wherein the basket of assets comprises two or more assets.

Exemplary aspects are directed toward any of the above aspects, further comprising wherein the basket of assets comprises three or more assets, wherein each asset makes up a different proportion of the basket of assets.

Exemplary aspects are directed toward any of the above aspects, further comprising wherein the resource is moved into or out of the fund physically by a resource delivery provider.

Exemplary aspects are directed toward any of the above aspects, further comprising wherein the second percent change is determined based on one or more exchange rates.

Exemplary aspects are directed toward any of the above aspects, further comprising wherein the first percent change in the value of the fund is determined based on a difference between an opening price and a closing price of the resource as traded on a market.

Exemplary aspects are directed toward any of the above aspects, further comprising wherein the value of the resource comprising the model is tracked by an index.

Exemplary aspects are directed toward any of the above aspects, further comprising wherein shares in the model are traded on a market.

Exemplary aspects are directed toward a system of modeling a financial transaction, the system comprising:

one or more processors in communication with a memory storing information indicative of a reference asset and a basket of assets in a memory;

a model holding a quantity of resources;

the one or more processors in communication with the memory determining a first percent change, the first percent change associated with a first value of a resource held in the model and being compared to the reference asset;

the one or more processors determining a second percent change, the second percent change associated with a value of the basket of assets held in memory and being compared to the reference asset;

the one or more processors, based on the first percent change and the second percent change, determining a quantity of a resource to be held in the model thereafter, to one of allocate to the model and remove from the model; and

the one or more processors, based on the determination of the quantity of the resource to be held in the model, one of automatically generating and electronically sending an instruction to move the quantity of the resource into or out of the model, wherein the value of the model reflects a direct comparison between the value of the resource and the value of the basket of assets.

Exemplary aspects are directed toward any of the above aspects, further comprising wherein the resource comprises gold bullion.

Exemplary aspects are directed toward any of the above aspects, further comprising wherein the first percent change is determined daily.

Exemplary aspects are directed toward any of the above aspects, further comprising wherein the basket of assets comprises two or more assets.

Exemplary aspects are directed toward any of the above aspects, further comprising wherein the basket of assets comprises three or more assets, wherein each asset makes up a different proportion of the basket of assets.

Exemplary aspects are directed toward any of the above aspects, further comprising wherein the resource is moved into or out of the fund physically by a resource delivery provider.

Exemplary aspects are directed toward any of the above aspects, further comprising wherein the second percent change is determined based on one or more exchange rates.

Exemplary aspects are directed toward any of the above aspects, further comprising wherein the first percent change in the value of the fund is determined based on a difference between an opening price and a closing price of the resource as traded on a market.

Exemplary aspects are directed toward any of the above aspects, further comprising wherein the value of the resource comprising the model is tracked by an index.

Exemplary aspects are directed toward a computer system, comprising:

one or more processors, one or more computer-readable memories and one or more computer-readable, tangible storage devices; and

program instructions, stored on at least one of the one or more computer-readable, tangible storage devices for execution by at least one of the one or more processors via at least one of the one or more memories, to:
store information indicative of a reference asset and a basket of assets in a memory;
hold a quantity of resources in a model;
determine, by one or more processors in communication with the memory, a first percent change, the first percent change associated with a first value of a resource held in the model and being compared to the reference asset;
determine, by the one or more processors, a second percent change, the second percent change associated with a value of the basket of assets held in memory and being compared to the reference asset;
determine, by the one or more processors, based on the first percent change and the second percent change, a quantity of a resource to be held in the model thereafter, to one of allocate to the model and remove from the model; and
based on the determination of the quantity of the resource to be held in the model, one of automatically generate and electronically send an instruction to move the quantity of the resource into or out of the model, wherein the value of the model reflects a direct comparison between the value of the resource and the value of the basket of assets.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, Wi-Fi, LTE, 4G, Bluetooth®, WirelessHD, WiGig, WiGi, 3GPP, Wireless LAN, WiMAX, and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™ processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

What is claimed is:

1. A method for modeling a financial transaction, the method comprising:
storing information indicative of a reference asset and a basket of assets in a memory;
holding a quantity of resources in a model;
determining, by one or more processors in communication with the memory, a first percent change, the first percent change associated with a first value of a resource held in the model and being compared to the reference asset;
determining, by the one or more processors, a second percent change, the second percent change associated with a value of the basket of assets held in memory and being compared to the reference asset;
determining, by the one or more processors, based on the first percent change and the second percent change, a quantity of a resource to be held in the model thereafter, to one of allocate to the model and remove from the model; and
based on the determination of the quantity of the resource to be held in the model, one of automatically generating and electronically sending an instruction to move the quantity of the resource into or out of the model, wherein the value of the model reflects a direct comparison between the value of the resource and the value of the basket of assets.

2. The method of claim 1, wherein the resource comprises gold bullion.

3. The method of claim 1, wherein the first percent change determined daily.

4. The method of claim 1, wherein the basket of assets comprises two or more assets.

5. The method of claim 1, wherein the basket of assets comprises three or more assets, wherein each asset makes up a different proportion of the basket of assets.

6. The method of claim 1, wherein the resource is moved into or out of the fund physically by a resource delivery provider.

7. The method of claim 1, wherein the second percent change is determined based on one or more exchange rates.

8. The method of claim 1, wherein the first percent change in the value of the fund is determined based on a difference between an opening price and a closing price of the resource as traded on a market.

9. The method of claim 1, wherein the value of the resource comprising the model is tracked by an index.

10. The method of claim 1, wherein shares in the model are traded on a market.

11. A system of modeling a financial transaction, the system comprising:
one or more processors in communication with a memory storing information indicative of a reference asset and a basket of assets;
a model holding a quantity of resources;
the one or more processors in communication with the memory determining a first percent change, the first percent change associated with a first value of a resource held in the model and being compared to the reference asset;
the one or more processors determining a second percent change, the second percent change associated with a value of the basket of assets held in memory and being compared to the reference asset;
the one or more processors, based on the first percent change and the second percent change, determining a quantity of a resource to be held in the model thereafter, to one of allocate to the model and remove from the model; and
the one or more processors, based on the determination of the quantity of the resource to be held in the model, one of automatically generating and electronically sending an instruction to move the quantity of the resource into or out of the model, wherein the value of the model reflects a direct comparison between the value of the resource and the value of the basket of assets.

12. The system of claim 11, wherein the resource comprises gold bullion.

13. The system of claim 11, wherein the first percent change determined daily.

14. The system of claim 11, wherein the basket of assets comprises two or more assets.

15. The system of claim 11, wherein the basket of assets comprises three or more assets, wherein each asset makes up a different proportion of the basket of assets.

16. The system of claim 11, wherein the resource is moved into or out of the fund physically by a resource delivery provider.

17. The system of claim 11, wherein the second percent change is determined based on one or more exchange rates.

18. The system of claim 11, wherein the first percent change in the value of the fund is determined based on a difference between an opening price and a closing price of the resource as traded on a market.

19. The system of claim 11, wherein the value of the resource comprising the model is tracked by an index.

20. A computer system, comprising:
one or more processors, one or more computer-readable memories and one or more computer-readable, tangible storage devices; and
program instructions, stored on at least one of the one or more computer-readable, tangible storage devices for execution by at least one of the one or more processors via at least one of the one or more memories, to:
store information indicative of a reference asset and a basket of assets in a memory;
hold a quantity of resources in a model;
determine, by one or more processors in communication with the memory, a first percent change, the first percent change associated with a first value of a resource held in the model and being compared to the reference asset;
determine, by the one or more processors, a second percent change, the second percent change associated with a value of the basket of assets held in memory and being compared to the reference asset;
determine, by the one or more processors, based on the first percent change and the second percent change, a quantity of a resource to be held in the model thereafter, to one of allocate to the model and remove from the model; and
based on the determination of the quantity of the resource to be held in the model, one of automatically generate and electronically send an instruction to move the quantity of the resource into or out of the model, wherein the value of the model reflects a direct comparison between the value of the resource and the value of the basket of assets.
